(19) United States
(12) Patent Application Publication
(10) Pub. No.: US 2025/0246002 A1
(43) Pub. Date: Jul. 31, 2025

(54) IMAGE RECOGNITION DEVICE, IMAGE RECOGNITION METHOD, AND NON-TRANSITORY RECORDING MEDIUM

(71) Applicant: TOYOTA JIDOSHA KABUSHIKI KAISHA, Toyota-shi Aichi-ken (JP)

(72) Inventors: Shuntaro Shinohara, Edogawa-ku Tokyo-to (JP); Toshiki Matsui, Ichikawa-shi Chiba-ken (JP); Takahiro Furukawa, Nagoya-shi Aichi-ken (JP); Suzuka Kondo, Nishitokyo-shi Tokyo-to (JP); Ryutaro Araki, Edogawa-ku Tokyo-to (JP); Masao Ueyama, Kawasaki-shi Kanagawa-ken (JP); Ryotaro Araki, Koto-ku Tokyo-to (JP)

(73) Assignee: TOYOTA JIDOSHA KABUSHIKI KAISHA, Toyota-shi Aichi-ken (JP)

(21) Appl. No.: 19/037,373

(22) Filed: Jan. 27, 2025

(30) Foreign Application Priority Data
Jan. 31, 2024 (JP) 2024-012779

(51) Int. Cl. G06V 20/58; G06V 10/75; G06V 10/764; G06V 40/10

(52) U.S. Cl. CPC G06V 20/58; G06V 10/75; G06V 10/764; G06V 40/10

(57) ABSTRACT

An image recognition device acquires a camera image showing an outside of a host vehicle, determines classification of an object included in the camera image, calculates a confidence score of the classification of the object, recognizes that the object having the determined classification is included in the camera image when the confidence score is equal to or greater than a score threshold value, changes the score threshold value, and calculates the number of wireless communication base stations transmitting signals which can be received with signal strength equal to or greater than a signal strength threshold value in a wireless communication device mounted on the host vehicle.

### CROSS-REFERENCE TO RELATED APPLICATIONS

This application claims priority to Japanese Patent Application No. 2024-012779 filed Jan. 31, 2024, the entire contents of which are herein incorporated by reference.

### FIELD

The present disclosure relates to image recognition device, image recognition method, and non-transitory recording medium.

### BACKGROUND

PTL 1 (JP-A-2014-178736) discloses a technique in which image recognition is performed in accordance with a change in an environmental condition around a detection object. In the technique described in PTL 1, the image recognition for an input image is performed by giving weight corresponding to the environmental condition that is determined from external environment. Further, in the technology described in PTL 1, city area, suburb, mountainous region, etc. are included in the external environment. Furthermore, in the technique described in PTL 1, in order to obtain information about the external environment, a communication device that receives regional information provided from an external organization, an input device for inputting the map information stored in a map database, and the like are used.

In the technique described in PTL 1, because visibility of the detection object changes when the environmental condition differs, the image recognition is performed in accordance with the change in the environmental condition. That is, the technique described in PTL 1, there is no concept of avoiding time and cost of determination whether a pedestrian is included in a camera image shot in the mountainous region because the pedestrian seldom exists in the mountainous region, and concept of avoiding time and cost of determination whether animal excluding human is included in the camera image shot in a place where there are many humans because probability of animals appearing is low in the place where there are many humans. Therefore, in the technique described in PTL 1, it is impossible to improve image recognition accuracy while suppressing time and cost required for the image recognition.

### SUMMARY

In view of the above-described points, it is an object of the present disclosure to provide image recognition device, image recognition method, and non-transitory recording medium that can improve image recognition accuracy while suppressing time and cost required for image recognition.

(1) One aspect of the present disclosure is an image recognition device including a processor configured to: acquire a camera image showing an outside of a host vehicle shot by a camera; determine classification of an object included in the camera image and calculate a confidence score of the classification of the object; recognize that the object having the determined classification is included in the camera image when the calculated confidence score is equal to or greater than a score threshold value; change the score threshold value; and calculate the number of wireless communication base stations transmitting signals which can be received with signal strength equal to or greater than a signal strength threshold value in a wireless communication device mounted on the host vehicle, wherein at least pedestrian and animal excluding human are included in the determined classification of the object, the processor is configured to perform at least one of decreasing the score threshold value which is compared with the confidence score of the animal excluding human when the calculated number of the wireless communication base stations is equal to or less than a base station number threshold value, than when the calculated number of the wireless communication base stations is greater than the base station number threshold value, and decreasing the score threshold value which is compared with the confidence score of the pedestrian when the calculated number of the wireless communication base stations is greater than the base station number threshold value, than when the calculated number of the wireless communication base stations is equal to or less than the base station number threshold value.

(2) In the image recognition device of the aspect (1), a cliff may be included in the determined classification of the object, the processor may be configured to decrease the score threshold value which is compared with the confidence score of the cliff when the calculated number of the wireless communication base stations is equal to or less than the base station number threshold value, than when the calculated number of the wireless communication base stations is greater than the base station number threshold value.

(3) In the image recognition device of the aspect (1) or (2), WiFi base stations and Bluetooth base stations may be included in the wireless communication base stations, the processor may be configured to perform at least one of decreasing the score threshold value which is compared with the confidence score of the animal excluding human when the calculated number of the Bluetooth base stations is equal to or less than the base station number threshold value, than when the calculated number of the Bluetooth base stations is greater than the base station number threshold value, and decreasing the score threshold value which is compared with the confidence score of the pedestrian when the calculated number of the Bluetooth base stations is greater than the base station number threshold value, than when the calculated number of the Bluetooth base stations is equal to or less than the base station number threshold value.

(4) Another aspect of the present disclosure is an image recognition method including: acquiring a camera image showing an outside of a host vehicle shot by a camera; determining classification of an object included in the camera image and calculating a confidence score of the classification of the object; recognizing that the object having the determined classification is included in the camera image when the calculated confidence score is equal to or greater than a score threshold value; changing the score threshold value; and calculating the number of wireless communication base stations transmitting signals which can be received with signal strength equal to or greater than a signal strength threshold value in a wireless communication device mounted on the host vehicle, wherein at least pedestrian and animal excluding human are included in the determined classification of the object, at least one of decreasing the score threshold value which is compared with the confidence score of the animal excluding human when the calculated number of the wireless communication base stations is equal to or less than a base station number threshold value, than when the calculated number of the wireless communication base stations is greater than the base station number threshold value, and decreasing the score threshold value which is compared with the confidence score of the pedestrian when the calculated number of the wireless communication base stations is greater than the base station number threshold value, than when the calculated number of the wireless communication base stations is equal to or less than the base station number threshold value is performed.

(5) Another aspect of the present disclosure is a non-transitory recording medium having recorded thereon a computer program for causing a processor to perform a process including: acquiring a camera image showing an outside of a host vehicle shot by a camera; determining classification of an object included in the camera image and calculating a confidence score of the classification of the object; recognizing that the object having the determined classification is included in the camera image when the calculated confidence score is equal to or greater than a score threshold value; changing the score threshold value; and calculating the number of wireless communication base stations transmitting signals which can be received with signal strength equal to or greater than a signal strength threshold value in a wireless communication device mounted on the host vehicle, wherein at least pedestrian and animal excluding human are included in the determined classification of the object, at least one of decreasing the score threshold value which is compared with the confidence score of the animal excluding human when the calculated number of the wireless communication base stations is equal to or less than a base station number threshold value, than when the calculated number of the wireless communication base stations is greater than the base station number threshold value, and decreasing the score threshold value which is compared with the confidence score of the pedestrian when the calculated number of the wireless communication base stations is greater than the base station number threshold value, than when the calculated number of the wireless communication base stations is equal to or less than the base station number threshold value is performed.

According to the present disclosure, it is possible to improve image recognition accuracy while suppressing time and cost required for image recognition.

### BRIEF DESCRIPTION OF DRAWINGS

FIG. 1 is a view showing an example of a host vehicle 1 to which an image recognition device 15 of a first embodiment is applied.

FIG. 2 is a view showing an example of the relationship between the host vehicle and wireless communication base stations.

FIG. 3A shows an example of a learning camera image used for learning of a model by which a determination unit 3B can determine that classification of an object included in an camera image acquired by an acquisition unit 3A is a pedestrian (specifically, pedestrian crossing a road on which the host vehicle 1 is traveling).

FIG. 3B shows an example of the learning camera image used for learning of the model by which the determination unit 3B can determine that the classification of the object included in the camera image acquired by the acquisition unit 3A is an animal excluding human (specifically, animal excluding human crossing the road on which the host vehicle 1 is traveling).

FIG. 3C shows an example of the learning camera image used for learning of the model by which the determination unit 3B can determine that the classification of the object included in the camera image acquired by the acquisition unit 3A is a cliff (specifically, cliff existing on a side of the road on which the host vehicle 1 is traveling).

FIG. 4 is a flowchart for explaining an example of a process performed by a processor of the image recognition device of the first embodiment.

### DESCRIPTION OF EMBODIMENTS

Below, referring to the drawings, embodiments of image recognition device, image recognition method, and non-transitory recording medium of the present disclosure will be explained.

### First Embodiment

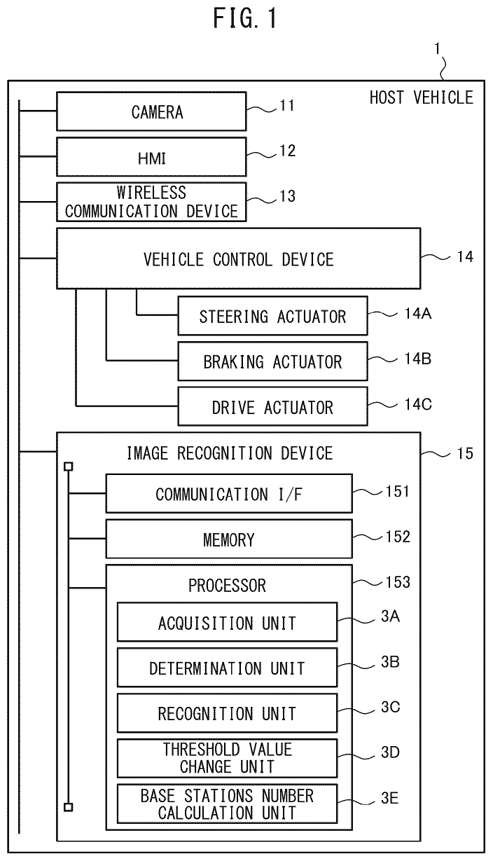

FIG. 1 is a view showing an example of a host vehicle 1 to which an image recognition device 15 of a first embodiment is applied. In the example shown in FIG. 1, the host vehicle 1 includes camera 11, HMI (Human Machine Interface) 12, wireless communication device 13, vehicle control device 14, steering actuator 14A, braking actuator 14B, drive actuator 14C, and image recognition device 15.

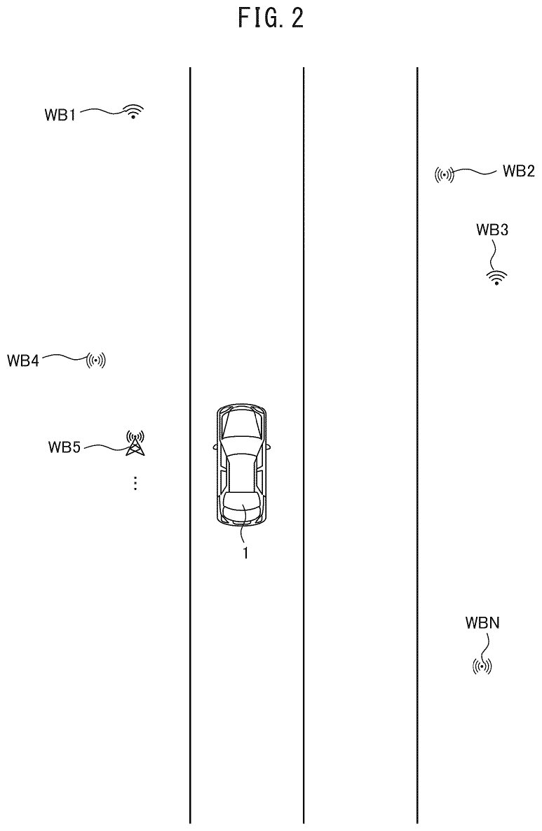

The camera 11 shoots an outside of the host vehicle 1 and transmits a camera image showing the outside of the host vehicle 1 to the image recognition device 15. The HMI 12 has the function of receiving various operations of a driver of the host vehicle 1 and the like and transmits a signal showing the operation of the driver of the host vehicle 1 to the vehicle control device 14. The wireless communication device 13 communicates with wireless communication base stations WB1 to WBN (refer to FIG. 2) and the like outside the host vehicle 1.

FIG. 2 is a view showing an example of the relationship between the host vehicle 1 and the wireless communication base stations WB1 to WBN. Specifically, FIG. 2 shows the example of the relationship between the host vehicle 1 traveling in an urban area and the wireless communication base stations WB1 to WBN existing in the vicinity of the host vehicle 1.

In the example shown in FIG. 2, the wireless communication device 13 of the host vehicle 1 receives the signal (radio wave) transmitted from WiFi base stations (WiFi access points) as the wireless communication base stations WB1, WB3 with signal strength equal to or greater than a signal strength threshold value. The wireless communication device 13 receives the signal (radio wave) transmitted from Bluetooth base stations (BLE (Bluetooth Low Energy) icons) as the wireless communication base stations WB2, WB4, WBN with the signal strength equal to or greater than the signal strength threshold value. Furthermore, the wireless communication device 13 receives the signal (radio wave) transmitted from a mobile phone base station as the wireless communication base station WB5 with the signal strength equal to or greater than the signal strength threshold value.

In the example shown in FIG. 2, the wireless communication device 13 does not receive the signal (WiFi signal, Bluetooth signal of the like) transmitted from a mobile terminal such as smartphone, notebook PC, game console or the like, but in another example, the wireless communication device 13 may receive the signal transmitted from the mobile terminal as the signal transmitted from the wireless communication base station.

In the example shown in FIG. 2 in which the host vehicle 1 is traveling in the urban area, the wireless communication device 13 of the host vehicle 1 receives the signals transmitted from a large number of the wireless communication base stations WB1 to WBN with the signal strength equal to or greater than the signal strength threshold value. On the other hand, when the host vehicle 1 is traveling in a mountainous region, the number of the signals transmitted from the wireless communication base stations and received by the wireless communication device 13 of the host vehicle 1 with the signal strength equal to or greater than the signal strength threshold value is less than the example shown in FIG. 2.

In the example shown in FIG. 1, the vehicle control device 14 controls the steering actuator 14A, the braking actuator 14B, and the drive actuator 14C based on the signal (signal showing the operation of the driver of the host vehicle 1) transmitted from the HMI 12, result of image recognition to be described later performed by the image recognition device 15 and the like.

Specifically, in the example shown in FIG. 1, the vehicle control device 14 has the function of driving assistance. Specifically, the vehicle control device 14 has the function of, for example, activating the braking actuator 14B based on the result of the image recognition of the image recognition device 15 without the need for the driver of the host vehicle 1 to activate the braking actuator 14B in order to avoid a collision between the host vehicle 1 and a pedestrian when the camera image including the pedestrian crossing a road on which the host vehicle 1 is traveling is transmitted from the camera 11 to the image recognition device 15, and the like.

In another example, the vehicle control device 14 may have an autonomous driving function that controls the steering actuator 14A, the braking actuator 14B, and the drive actuator 14C and makes the host vehicle 1 travel autonomously based on travel plan, the result of the image recognition of the image recognition device 15 and the like without the need for the operation by the driver of the host vehicle 1.

In the example shown in FIG. 1, the image recognition device 15 is configured by a microcomputer which includes communication interface (I/F) 151, memory 152 and processor 153. The communication interface 151 includes an interface circuit for connecting the image recognition device 15 to the camera 11, the 12, the wireless communication device 13 and the vehicle control device 14. The memory 152 stores a program used in a process performed by the processor 153 and various data. The processor 153 has the function as an acquisition unit 3A, the function as a determination unit 3B, the function as a recognition unit 3C, the function as a threshold value change unit 3D and the function as a base stations number calculation unit 3E.

The acquisition unit 3A acquires the camera image showing the outside of the host vehicle 1 shot by the camera 11. The determination unit 3B determines classification of an object included in the camera image acquired by the acquisition unit 3A and calculates a confidence score of the classification of the object. The determination unit 3B determines the classification of the object included in the camera image acquired by the acquisition unit 3A by using a model obtained by performing learning using teacher data which is a data set of a learning camera image shot by a camera mounted on a learning vehicle and a label showing the classification of the object included in the learning camera image, for example. The recognition unit 3C recognizes that the object having the classification determined by the determination unit 3B is included in the camera image acquired by the acquisition unit 3A when the confidence score calculated by the determination unit 3B is equal to or greater than the score threshold value.

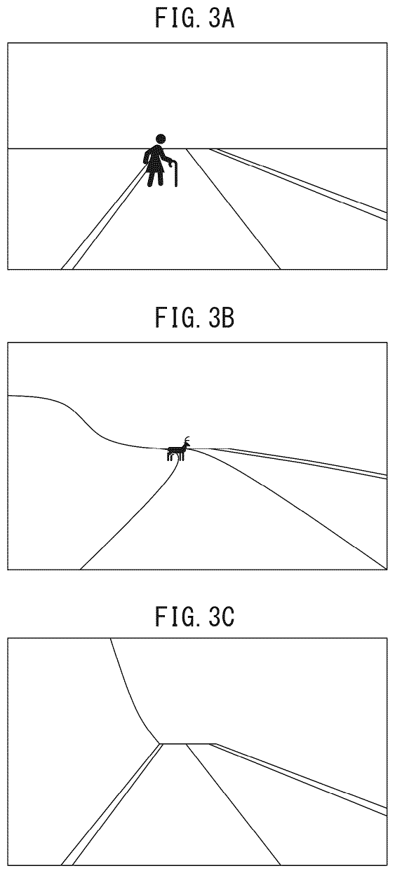

FIG. 3A to FIG. 3C are views showing examples of learning camera images used for the learning of the model used by the determination unit 3B. In detail, FIG. 3A shows the example of the learning camera image used for the learning of the model by which the determination unit 3B can determine that the classification of the object included in the camera image acquired by the acquisition unit 3A is the pedestrian (specifically, pedestrian crossing the road on which the host vehicle 1 is traveling). FIG. 3B shows the example of the learning camera image used for the learning of the model by which the determination unit 3B can determine that the classification of the object included in the camera image acquired by the acquisition unit 3A is an animal excluding human (specifically, animal excluding human crossing the road on which the host vehicle 1 is traveling). FIG. 3C shows the example of the learning camera image used for the learning of the model by which the determination unit 3B can determine that the classification of the object included in the camera image acquired by the acquisition unit 3A is a cliff (specifically, cliff existing on a side of the road on which the host vehicle 1 is traveling).

The learning camera image as shown in FIG. 3A (camera image including the pedestrian crossing the road on which the learning vehicle is traveling) can be obtained relatively easily, for example, by the learning vehicle traveling in the urban area.

On the other hand, the learning camera image as shown in FIG. 3B (learning camera image including the animal excluding human, the animal crossing the road on which the learning vehicle is traveling) cannot be easily obtained even if, for example, the learning vehicle travels in the mountainous region. In addition, many learning camera images as shown in FIG. 3B need to be prepared for the learning of the model in order to allow the determination unit 3B to determine that the classification of the object included in the camera image acquired by the acquisition unit 3A is the animal excluding human as shown in the FIG. 3B, and allow the determination unit 3B to calculate the high confidence score as the confidence score of the classification (animal excluding human) of the object. In order to prepare many learning camera images as shown in FIG. 3B, it is necessary to increase the mileage of the learning vehicle, cost becomes high. On the other hand, when the determination unit 3B calculates a relatively lower confidence score as the confidence score of the classification (animal excluding human) of the object and when the confidence score is less than the score threshold value, the recognition unit 3C does not recognize that the object having the classification (animal excluding human) determined by the determination unit 3B is included in the camera image, therefore it takes a long time to obtain the result of the image recognition of the image recognition device 15.

In addition, the learning camera image (learning camera image including the cliff existing on the side of the road on which the learning vehicle is traveling) as shown in FIG. 3C cannot be obtained even if the learning vehicle travels in the urban area, and can only be obtained if the learning vehicle travels in the mountainous region. Further, many learning camera images as shown in FIG. 3C need to be prepared for the learning of the model in order to allow the determination unit 3B to determine that the classification of the object included in the camera image acquired by the acquisition unit 3A is the cliff as shown in the FIG. 3C, and allow the determination unit 3B to calculate the high confidence score as the confidence score of the classification (cliff) of the object. In order to prepare many learning camera images as shown in FIG. 3C, it is necessary to increase the mileage of the learning vehicle, cost becomes high.

In view of the above-described points, in the image recognition device 15 of the first embodiment, countermeasures to be described later using the above-described property are implemented, the above-described property is that the number of the signals transmitted from the wireless communication base station and received by the wireless communication device 13 of the host vehicle 1 with the signal strength equal to or greater than the signal strength threshold value when the host vehicle 1 is traveling in the mountainous region is less than the example shown in FIG. 2.

In the example shown in FIG. 1, the threshold value change unit 3D has the function of changing the score threshold value. The base stations number calculation unit 3E calculates the number of the wireless communication base stations WB1 to WBN (refer to FIG. 2) transmitting the signals which can be received with the signal strength equal to or greater than the signal strength threshold value in the wireless communication device 13.

Specifically, in the example shown in FIG. 1, the threshold value change unit 3D decreases the score threshold value which is compared with the confidence score of the animal excluding human (that is, the threshold value change unit 3D makes it easier for the recognition unit 3C to recognize that the animal excluding human is included in the camera image) when the number of the wireless communication base stations WB1 to WBN calculated by the base stations number calculation unit 3E is equal to or less than a base station number threshold value (for example, when the host vehicle 1 is traveling in the mountainous region), than when the number of the wireless communication base stations WB1 to WBN calculated by the base stations number calculation unit 3E is greater than the base station number threshold value (for example, when the host vehicle 1 is traveling in the urban area). Further, the threshold value change unit 3D decreases the score threshold value which is compared with the confidence score of the cliff (that is, the threshold value change unit 3D makes it easier for the recognition unit 3C to recognize that the cliff is included in the camera image) when the number of the wireless communication base stations WB1 to WBN calculated by the base stations number calculation unit 3E is equal to or less than the base station number threshold value (for example, when the host vehicle 1 is traveling in the mountainous region), than when the number of the wireless communication base stations WB1 to WBN calculated by the base stations number calculation unit 3E is greater than the base station number threshold value (for example, when the host vehicle 1 is traveling in the urban area). Furthermore, the threshold value change unit 3D increases the score threshold value which is compared with the confidence score of the pedestrian (that is, the threshold value change unit 3D makes it more difficult for the recognition unit 3C to recognize that the pedestrian is included in the camera image) when the number of the wireless communication base stations WB1 to WBN calculated by the base stations number calculation unit 3E is equal to or less than the base station number threshold value (for example, when the host vehicle 1 is traveling in the mountainous region), than when the number of the wireless communication base stations WB1 to WBN calculated by the base stations number calculation unit 3E is greater than the base station number threshold value (for example, when the host vehicle 1 is traveling in the urban area).

Furthermore, in the example shown in FIG. 1, the threshold value change unit 3D increases the score threshold value which is compared with the confidence score of the animal excluding human (that is, the threshold value change unit 3D makes it more difficult for the recognition unit 3C to recognize that the animal excluding human is included in the camera image) when the number of the wireless communication base stations WB1 to WBN calculated by the base stations number calculation unit 3E is greater than the base station number threshold value (for example, when the host vehicle 1 is traveling in the urban area), than when the number of the wireless communication base stations WB1 to WBN calculated by the base stations number calculation unit 3E is equal to or less than the base station number threshold value (for example, when the host vehicle 1 is traveling in the mountainous region). Further, the threshold value change unit 3D increases the score threshold value which is compared with the confidence score of the cliff (that is, the threshold value change unit 3D makes it more difficult for the recognition unit 3C to recognize that the cliff is included in the camera image) when the number of the wireless communication base stations WB1 to WBN calculated by the base stations number calculation unit 3E is greater than the base station number threshold value (for example, when the host vehicle 1 is traveling in the urban area), than when the number of the wireless communication base stations WB1 to WBN calculated by the base stations number calculation unit 3E is equal to or less than the base station number threshold value (for example, when the host vehicle 1 is traveling in the mountainous region). Furthermore, the threshold value change unit 3D decreases the score threshold value which is compared with the confidence score of the pedestrian (that is, the threshold value change unit 3D makes it easier for the recognition unit 3C to recognize that the pedestrian is included in the camera image) when the number of the wireless communication base stations WB1 to WBN calculated by the base stations number calculation unit 3E is greater than the base station number threshold value (for example, when the host vehicle 1 is traveling in the urban area), than when the number of the wireless communication base stations WB1 to WBN calculated by the base stations number calculation unit 3E is equal to or less than the base station number threshold value (for example, when the host vehicle 1 is traveling in the mountainous region).

That is, in the example shown in FIG. 1, the threshold value change unit 3D changes the score threshold value which is compared with the confidence score of the animal excluding human, changes the score threshold value which is compared with the confidence score of the cliff, and changes the score threshold value which is compared with the confidence score of the pedestrian based on the number of the wireless communication base stations WB1 to WBN calculated by the base stations number calculation unit 3E. Therefore, in the example shown in FIG. 1, it is possible to improve image recognition accuracy while suppressing time and cost required for image recognition.

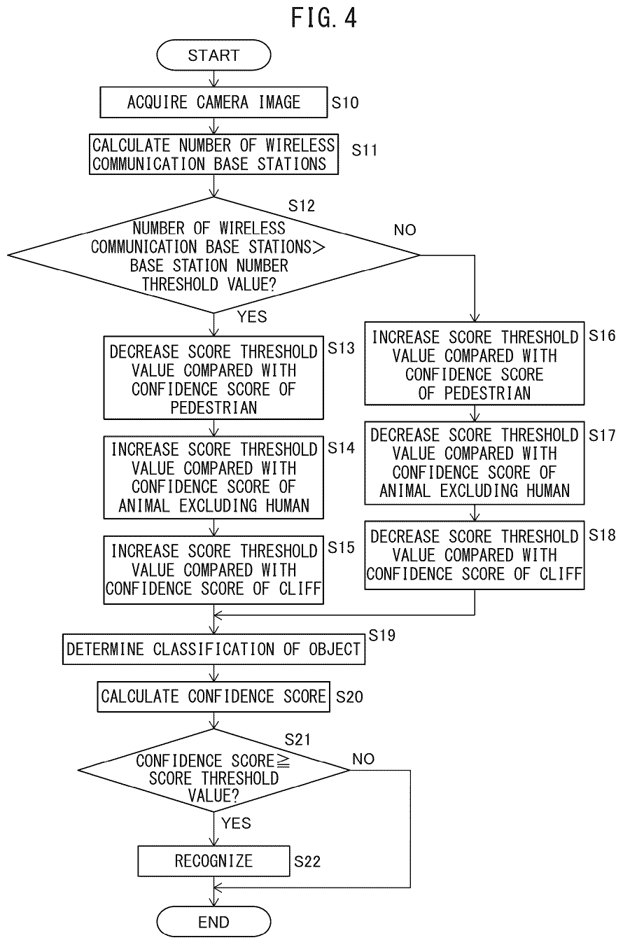

FIG. 4 is a flowchart for explaining an example of the process performed by the processor 153 of the image recognition device 15 of the first embodiment.

In the example shown in FIG. 4, at step S10, the acquisition unit 3A acquires the camera image showing the outside of the host vehicle 1 shot by the camera 11.

At step S11, the base stations number calculation unit 3E calculates the number of the wireless communication base stations WB1 to WBN transmitting the signals which can be received with the signal strength equal to or greater than the signal strength threshold value in the wireless communication device 13.

At step S12, for example, the threshold value change unit 3D determines whether the number of the wireless communication base stations WB1 to WBN calculated at step S12 is greater than the base station number threshold value. When YES, it proceeds to step S13; when NO, it proceeds to step S16.

At step S13, the threshold value change unit 3D decreases the score threshold value which is compared with the confidence score of the pedestrian than when the number of the wireless communication base stations WB1 to WBN is equal to or less than the base station number threshold value.

At step S14, the threshold value change unit 3D increases the score threshold value which is compared with the confidence score of the animal excluding human than when the number of the wireless communication base stations WB1 to WBN is equal to or less than the base station number threshold value.

At step S15, the threshold value change unit 3D increases the score threshold value which is compared with the confidence score of the cliff than when the number of the wireless communication base stations WB1 to WBN is equal to or less than the base station number threshold value. Then, it proceeds to step S19.

At step S16, the threshold value change unit 3D increases the score threshold value which is compared with the confidence score of the pedestrian than when the number of the wireless communication base stations WB1 to WBN is greater than the base station number threshold value.

At step S17, the threshold value change unit 3D decreases the score threshold value which is compared with the confidence score of the animal excluding human than when the number of the wireless communication base stations WB1 to WBN is greater than the base station number threshold value.

At step S18, the threshold value change unit 3D decreases the score threshold value which is compared with the confidence score of the cliff than when the number of the wireless communication base stations WB1 to WBN is greater than the base station number threshold value. Then, it proceeds to step S19.

At step S19, the determination unit 3B determines the classification of the object included in the camera image acquired at step S10.

At step S20, the determination unit 3B calculates the confidence score of the classification of the object.

At step S21, for example, the recognition unit 3C determines whether the confidence score calculated at step S20 is equal to or greater than the score threshold value. When YES, it proceeds to step S22 of steps; when NO, the process shown in FIG. 4 ends.

At step S22, the recognition unit 3C recognizes that the object having the classification determined at step S19 is included in the camera image acquired at step S10.

In the example shown in FIG. 1, the base stations number calculation unit 3E calculates the number of the wireless communication base stations WB1 to WBN (more detail, the sum of the number of the WiFi base stations, the number of the Bluetooth base stations and the number of the mobile phone base stations) transmitting the signals which can be received with the signal strength equal to or greater than the signal strength threshold value in the wireless communication device 13. Furthermore, the threshold value change unit 3D changes the score threshold value based on the number of the wireless communication base stations WB1 to WBN calculated by the base stations number calculation unit 3E.

In another example, the number of the Bluetooth base stations (WB2, WB4, WBN) among the wireless communication base stations WB1 to WBN is considered important. Specifically, in this example, the base stations number calculation unit 3E calculates the number of the Bluetooth base stations transmitting the signals which can be received with the signal strength equal to or greater than the signal strength threshold value in the wireless communication device 13. Furthermore, the threshold value change unit 3D changes the score threshold value based on the number of the Bluetooth base stations calculated by the base stations number calculation unit 3E.

Specifically, the threshold value change unit 3D decreases the score threshold value which is compared with the confidence score of the animal excluding human (that is, the threshold value change unit 3D makes it easier to recognize that the animal excluding human is included in the camera image) when the number of the Bluetooth base stations calculated by the base stations number calculation unit 3E is equal to or less than the base station number threshold value, than when the number of the Bluetooth base stations calculated by the base stations number calculation unit 3E is greater than the base station number threshold value. Further, the threshold value change unit 3D decreases the score threshold value which is compared with the confidence score of the cliff (that is, the threshold value change unit 3D makes it easier to recognize that the cliff is included in the camera image) when the number of the Bluetooth base stations calculated by the base stations number calculation unit 3E is equal to or less than the base station number threshold value, than when the number of the Bluetooth base stations calculated by the base stations number calculation unit 3E is greater than the base station number threshold value. Furthermore, the threshold value change unit 3D decreases the score threshold value which is compared with the confidence score of the pedestrian (that is, the threshold value change unit 3D makes it easier to recognize that the pedestrian is included in the camera image) when the number of the Bluetooth base stations calculated by the base stations number calculation unit 3E is greater than the base station number threshold value, than when the number of the Bluetooth base stations calculated by the base stations number calculation unit 3E is equal to or less than the base station number threshold value.

In yet another example, the number of the wireless communication base stations WB1 to WBN calculated by the base stations number calculation unit 3E may not include the number of the radio communication base station (e.g., smartphone, notebook PC, game console or the like transmitting Bluetooth signal, WiFi signal or the like) existing inside the host vehicle 1 (e.g., carried by an occupant of the host vehicle 1). A signal received by the wireless communication device 13 with the signal strength which does not change during a time period when the host vehicle 1 is traveling at a speed which is equal to or higher than a predetermined speed can be regarded as a signal transmitted from the wireless communication base station existing inside the host vehicle 1.

### Second Embodiment

The host vehicle 1 to which the image recognition device 15 of a second embodiment is applied is configured in the same manner as the host vehicle 1 to which the image recognition device 15 of the first embodiment described above is applied, except that it will be described later.

As described above, in the example (example shown in FIG. 4) of the process performed by the processor 153 of the image recognition device 15 of the first embodiment, at step S16, the threshold value change unit 3D increases the score threshold value which is compared with the confidence score of the pedestrian than when the number of the wireless communication base station WB1 to WBN is greater than the base station number threshold value, and at step S17, the threshold value change unit 3D decreases the score threshold value which is compared with the confidence score of the animal excluding human than when the number of the wireless communication base station WB1 to WBN is greater than the base station number threshold value.

In the host vehicle 1 to which the image recognition device 15 of the second embodiment is applied, step S17 may be executed without step S16 being executed.

Further, as described above, in the example (example shown in FIG. 4) of the process performed by the processor 153 of the image recognition device 15 of the first embodiment, at step S13, the threshold value change unit 3D decreases the score threshold value which is compared with the confidence score of the pedestrian than when the number of the wireless communication base station WB1 to WBN is equal to or less than the base station number threshold value, and at step S14, the threshold value change unit 3D increases the score threshold value which is compared with the confidence score of the animal excluding human than when the number of the wireless communication base station WB1 to WBN is equal to or less than the base station number threshold value.

In the host vehicle 1 to which the image recognition device 15 of the second embodiment is applied, step S13 may be executed without step S14 being executed.

### Third Embodiment

The host vehicle 1 to which the image recognition device 15 of a third embodiment is applied is configured similarly to the host vehicle 1 to which the image recognition device 15 of the first embodiment described above is applied, except that it will be described later.

As described above, in the example (example shown in FIG. 4) of the process performed by the processor 153 of the image recognition device 15 of the first embodiment, steps S13, S14, S15 are executed when the determination at step S12 is YES, and steps S16, S17, S18 are executed when the determination at step S12 is NO.

In the host vehicle 1 to which the image recognizing device 15 of the third embodiment is applied, only step S14 may be executed (steps S13, S15 may not be executed) when the determination at step S12 is YES, and only step S17 may be executed (steps S16, S18 may not be executed) when the determination at step S12 is NO.

### Fourth Embodiment

The host vehicle 1 to which the image recognition device 15 of a fourth embodiment is applied is configured similarly to the host vehicle 1 to which the image recognition device 15 of the first embodiment described above is applied, except that it will be described later.

In the host vehicle 1 to which the image recognizing device 15 of the fourth embodiment is applied, only step S13 may be executed (steps S14, S15 may not be executed) when the determination at step S12 is YES, and only step S16 may be executed (steps S17, S18 may not be executed) when the determination at step S12 is NO.

As described above, although the embodiments of the image recognition device, the image recognition method, and the non-transitory recording medium of the present disclosure have been described with reference to the drawings, the image recognition device, the image recognition method, and the non-transitory recording medium of the present disclosure are not limited to the above-described embodiments, and appropriate changes can be made without departing from the scope of the present disclosure. The configuration of each example of the embodiment described above may be appropriately combined. In each example of the above-described embodiment, the process performed in the image recognition device 15 has been described as the software process performed by executing the program, but the process performed in the image recognition device 15 may be the process performed by hardware. Alternatively, the process performed by the image recognition device 15 may be the process that combines both software and hardware. Further, the program (program for realizing the function of the processor 153 of the image recognition device 15) stored in the memory 152 of the image recognition device 15 may be recorded in a computer-readable storage medium (non-transitory recording medium) such as, semiconductor memory, magnetic recording medium, optical recording medium, or the like for providing, distribution or the like.

1. An image recognition device comprising a processor configured to:
acquire a camera image showing an outside of a host vehicle shot by a camera;
determine classification of an object included in the camera image and calculate a confidence score of the classification of the object;
recognize that the object having the determined classification is included in the camera image when the calculated confidence score is equal to or greater than a score threshold value;
change the score threshold value; and
calculate the number of wireless communication base stations transmitting signals which can be received with signal strength equal to or greater than a signal strength threshold value in a wireless communication device mounted on the host vehicle,
wherein at least pedestrian and animal excluding human are included in the determined classification of the object,
the processor is configured to perform at least one of
decreasing the score threshold value which is compared with the confidence score of the animal excluding human when the calculated number of the wireless communication base stations is equal to or less than a base station number threshold value, than when the calculated number of the wireless communication base stations is greater than the base station number threshold value, and
decreasing the score threshold value which is compared with the confidence score of the pedestrian when the calculated number of the wireless communication base stations is greater than the base station number threshold value, than when the calculated number of the wireless communication base stations is equal to or less than the base station number threshold value.

2. The image recognition device according to claim 1, wherein a cliff is included in the determined classification of the object,
the processor is configured to
decrease the score threshold value which is compared with the confidence score of the cliff when the calculated number of the wireless communication base stations is equal to or less than the base station number threshold value, than when the calculated number of the wireless communication base stations is greater than the base station number threshold value.

3. The image recognition device according to claim 1, wherein WiFi base stations and Bluetooth base stations are included in the wireless communication base stations,
the processor is configured to perform at least one of
decreasing the score threshold value which is compared with the confidence score of the animal excluding human when the calculated number of the Bluetooth base stations is equal to or less than the base station number threshold value, than when the calculated number of the Bluetooth base stations is greater than the base station number threshold value, and
decreasing the score threshold value which is compared with the confidence score of the pedestrian when the calculated number of the Bluetooth base stations is greater than the base station number threshold value, than when the calculated number of the Bluetooth base stations is equal to or less than the base station number threshold value.

4. An image recognition method comprising:
acquiring a camera image showing an outside of a host vehicle shot by a camera;
determining classification of an object included in the camera image and calculating a confidence score of the classification of the object;
recognizing that the object having the determined classification is included in the camera image when the calculated confidence score is equal to or greater than a score threshold value;
changing the score threshold value; and
calculating the number of wireless communication base stations transmitting signals which can be received with signal strength equal to or greater than a signal strength threshold value in a wireless communication device mounted on the host vehicle,
wherein at least pedestrian and animal excluding human are included in the determined classification of the object,
at least one of
decreasing the score threshold value which is compared with the confidence score of the animal excluding human when the calculated number of the wireless communication base stations is equal to or less than a base station number threshold value, than when the calculated number of the wireless communication base stations is greater than the base station number threshold value, and
decreasing the score threshold value which is compared with the confidence score of the pedestrian when the calculated number of the wireless communication base stations is greater than the base station number threshold value, than when the calculated number of the wireless communication base stations is equal to or less than the base station number threshold value
is performed.

5. A non-transitory recording medium having recorded thereon a computer program for causing a processor to perform a process comprising:
acquiring a camera image showing an outside of a host vehicle shot by a camera;
determining classification of an object included in the camera image and calculating a confidence score of the classification of the object;
recognizing that the object having the determined classification is included in the camera image when the calculated confidence score is equal to or greater than a score threshold value;
changing the score threshold value; and
calculating the number of wireless communication base stations transmitting signals which can be received with signal strength equal to or greater than a signal strength threshold value in a wireless communication device mounted on the host vehicle,
wherein at least pedestrian and animal excluding human are included in the determined classification of the object,
at least one of
decreasing the score threshold value which is compared with the confidence score of the animal excluding human when the calculated number of the wireless communication base stations is equal to or less than a base station number threshold value, than when the calculated number of the wireless communication base stations is greater than the base station number threshold value, and
decreasing the score threshold value which is compared with the confidence score of the pedestrian when the calculated number of the wireless communication base stations is greater than the base station number threshold value, than when the calculated number of the wireless communication base stations is equal to or less than the base station number threshold value
is performed.
